(19) United States
(12) Patent Application Publication
(10) Pub. No.: US 2012/0167348 A1
(43) Pub. Date: Jul. 5, 2012

(54) APPARATUS FOR GRIPPING HOUSEHOLD ITEMS AND METHOD FOR USING SAME

(76) Inventor: Bretton Gregory Adams, Ballston Lake, NY (US)

(21) Appl. No.: 13/179,791

(22) Filed: Jul. 11, 2011

Related U.S. Application Data
(60) Provisional application No. 61/367,257, filed on Jul. 23, 2010.

(51) Int. Cl. B25G 1/00; B25G 1/10

(52) U.S. Cl. 16/426

(57) ABSTRACT

The present invention comprises a handle or gripping device used for small household items such as a toothbrush, cooking and eating utensils, and other similarly sized items, specifically handles or grippers that provide an enlarged gripping surface for the item being held to make holding such item more comfortable for a person with an impaired ability to hold such items, and a method for using the same.

### CROSS-REFERENCE TO RELATED APPLICATIONS

This application claims the benefit of priority, under 35 USC 119(e)(1), of U.S. Provisional Application No. 61/367,257, which is entitled APPARATUS FOR GRIPPING HOUSEHOLD ITEMS, and filed with the United States Patent and Trademark Office on 23 Jul. 2010, which is incorporated herein by reference in its entirety.

### BACKGROUND OF THE INVENTION

1. Field of the Invention

This invention is in the field of handles or gripping devices used for small household items such as a toothbrush, cooking and eating utensils, and other similarly sized items, specifically handles or grippers that provide an enlarged gripping surface for the item being held to make holding such item more comfortable for a person with an impaired ability to hold such items.

2. Description of Related Art

US Patent Application 20080131842 (Edwards; filed Oct. 14, 2004 and published Jun. 5, 2008) teaches a multiple grip handle for dental and other hand-held oral hygiene implements, the handle being adapted to render the implement to which it is applied useable by individuals who have difficulty in firmly grasping a conventional oral hygiene implement handle, difficulty manipulating and stabilizing a handle during oral hygiene, or by individuals who have varying types of preferred grips. The multiple grip handle in the preferred embodiment is fabricated of thermoplastic with an elastomeric coating material having good cushioning, non-slipping, and antimicrobial properties. The handle also has a variable elliptical cross section, a central cavity to socket a brush neck or other equipment, a unique thumb/knuckle grip on the dorsal surface, a plurality of gripping elements on the ventral surface, and an extended distal portion to afford fine control, comfort and stability for whatever gripping style the user prefers. This invention is unique in that it is reverse-engineered and designed from the perspectives of ergonomics, sports, fitness, and disability as well as from a hygiene perspective. It was designed by forming a moldable material into multiple oral hygiene and dental fitness grip styles superimposed onto each other such that a multiple grip handle resulted that is especially applicable to toothbrushes but may also be adapted to other oral hygiene devices and possibly even other household implements that must be manipulated by hand. A unique dental fitness routine was designed, which resulted in further refinements to the handle. Oral hygiene has been redefined as dental fitness and the invention thus becomes a new type of oral hygiene device called a dental fitness device. The invention is stocky enough to eventually incorporate many types of modifications internally and externally. It is the first oral hygiene device ever designed that advances the concept of hygiene into fitness and is the basis for a proposed line of upcoming dental fitness products. The handle can turn almost any toothbrush and insertable toothbrush neck into a dental fitness device. Very importantly, this invention addresses the issues of self-inflicted cavities and gum problems as well as the naturally occurring ones and aims to help prevent both types of problems more effectively than prior art.

There is a need in the art for a device that easily holds multiple small implements and makes the handling of such implements easy for a person with hand injury,

### BRIEF DESCRIPTION OF THE DRAWINGS

FIG. 1 is a perspective view of one embodiment of a gripping tool showing a spherical body 100 penetrated by a bore 105, the bore being bordered by two flanges 110, with the bore and flanges penetrating said body 100 substantially along a diameter or other radius of the body;

FIG. 2 illustrates a toothbrush 205 coupled to the gripping tool of FIG. 1 being inserted through the bore 105;

FIG. 3 illustrates a pencil 305 coupled to the gripping tool of FIG. 1 being inserted through the bore 105; and

FIG. 4 illustrates a knife 405, fork 410 and spoon 415, each coupled to the gripping tool of FIG. 1 by being inserted through the bore 105.

FIG. 5 illustrates a wrench 505 coupled to the gripping tool of FIG. 1 being inserted through the bore 105.

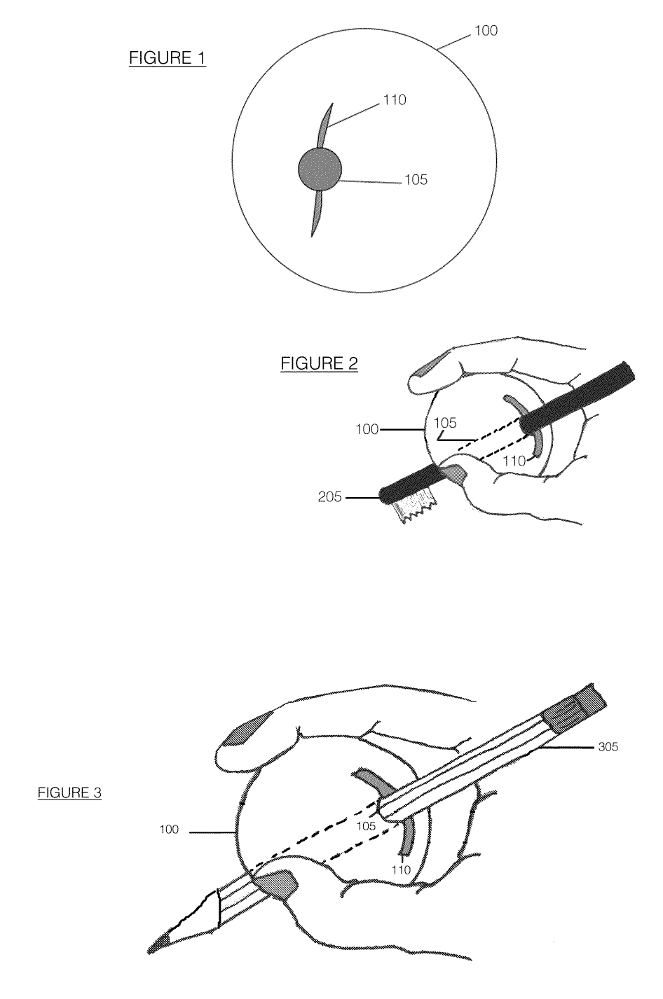

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

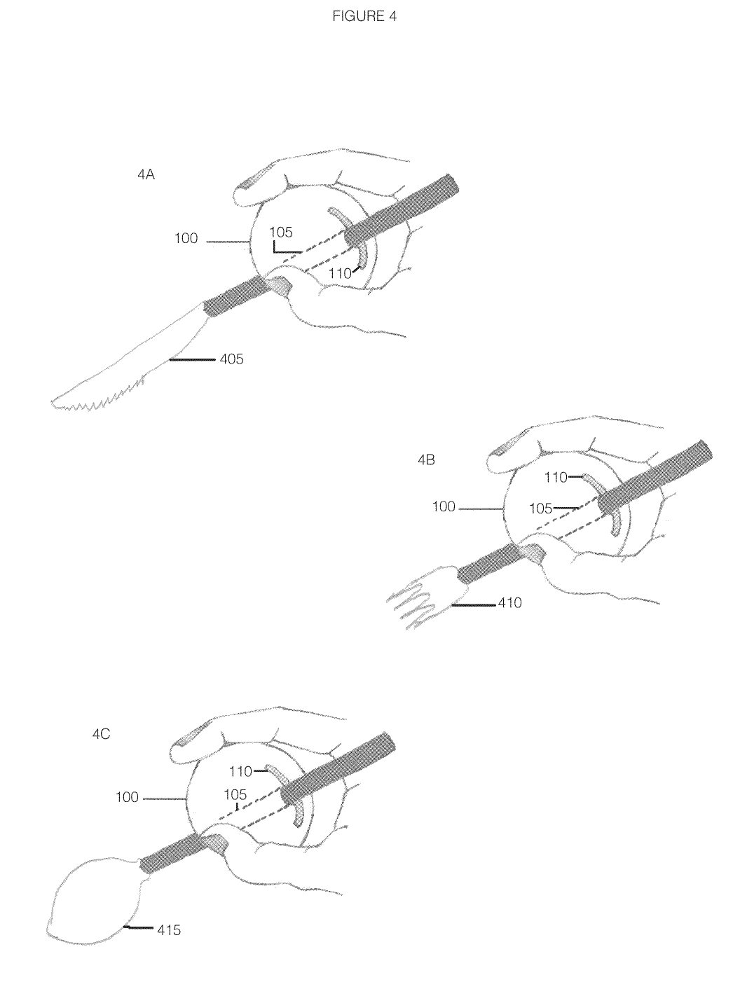

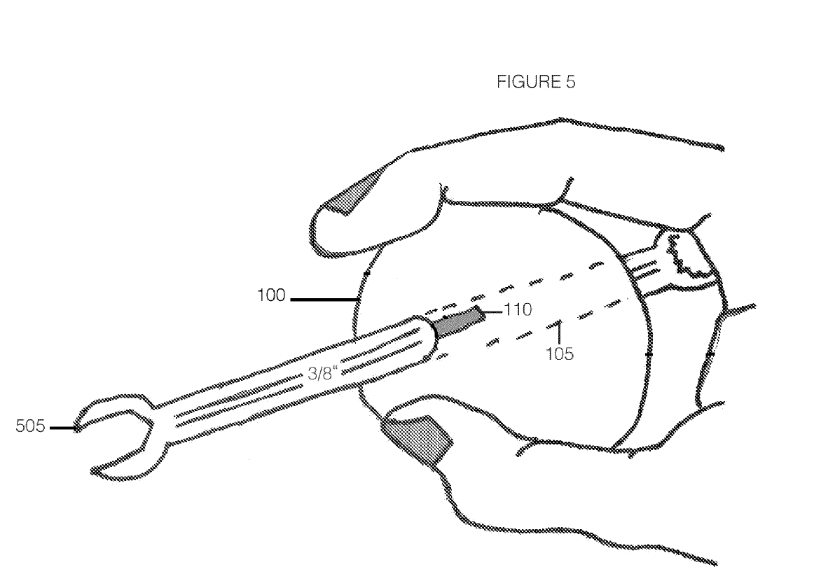

Broadly, one embodiment of the present invention generally provides an apparatus comprising a body 100 encompassing a bore 105 throughout the body 100. The bore 105 may optionally have flanges 110 that can be used to retractably expand the diameter of the bore 105. These assist a user with limited hand mobility or dexterity to grip various items. Persons may have limited hand mobility or dexterity due to hand, wrist, or finger injury, arthritis, or congenital malformation that negatively impacts their ability to grasp and maintain a grip on common objects and tools. For example, such an apparatus may be used in conjunction with household items such as a toothbrush 205, pencil 305, eating implement 405, 410, 415, or wrench 505 as illustrated in FIG. 2-FIG. 5. These are merely examples of possible uses of the present invention; other uses are possible and within the scope of the invention.

One embodiment of the present invention may have a configuration that is roughly spherical 100. Another embodiment of the present invention may have a configuration that is roughly cubic. Another embodiment of the present invention may have a configuration that is roughly solid rectangular. Another embodiment of the present invention may have a configuration that is roughly ellipsoid. The invention may be sized to accommodate an adult's hand or a child's hand.

The device may be comprised of a single piece of urethane rubber or a similar polymer. The device may also be seamed from two separate halves. The hardness of the material used to construct the device may have a durometer measurement in the range of 30-60 d in order for the device to be comfortable in a user's hand. The outside diameter of the device may range from 0.5-3.5 inches to accommodate varying hand sizes and levels of dexterity.

The interior section seeks to maintain the position of an object inserted into the device while the exterior of the devices offers the user a comfortable gripping surface to manipulate the inserted object by using friction, although other methods of securing the position of the object are within the scope of the invention. The exterior of the device may support a user's hand and may offer a larger, comfortable gripping surface and gripping position for holding a variety of items a user may find difficult to grasp due to limited hand mobility and/or dexterity.

The device may include a substantially central bore 105 that may be cylindrical, cubic, solid rectangular, or ellipsoid in shape for accommodating various items. The bore 105 may measure, at its widest point, substantially in the range of 1/32″-¾″. The bore 105 may optionally also include lateral wings 110 that may range substantially from ¼″-2¾″ in width. The lateral wings 110 may run the length of the bore 105 to allow for different shaped objects to be inserted through the device. The number of lateral wings 110 may be one, two, three, four, five, six, or more. The material used to make the device may also be flexible in order to allow easier insertion of various items through the device. Friction may be created within the center bore 105 when flexing pressure is released. This friction, along with the relative stickiness of the material used to construct the device, may serve to maintain the position of an object inserted in the device.

The device may be constructed through injection molding or any other method suitable for forming a solid body 100 encompassing a bore 105. Variations in the material, overall size, size of the bore 105, and/or size of the lateral wings 110 may be made in order to accommodate different sized objects. However, the overall size must be of such a size as to easily accommodate a human hand, sized for either an adult or a child.

To use the device, a user may first grip the body 100 and then insert and slide an object 115, 205, 305, 405, 410, 415, 505 through the bore 105 until the object 115, 205, 305, 405, 410, 415, 505 protrudes a desired distance from the opposite side of the body 100. The object is frictionally held in place through contact with the sides of the bore 105 and/or of the lateral wings 110. The user may grip the body 100 to manipulate the object 205, 305, 405, 410, 415, 505 for its desired use. Narrow objects, including but not limited to writing instruments 305, eating implements 405, 410, 415, toothbrushes 205, or narrow-handled tools 505 such as fine-work screwdrivers, may be held directly in the open bore 105 and may require little flexing of the lateral wings 110. Larger objects may also be inserted through the bore 105, but may require extra initial pressure to flex the lateral wings 110 and a bore 105 that is large enough to accommodate the wider object 205, 305, 405, 410, 415, 505. A user may remove the object 205, 305, 405, 410, 415, 505 in a similar fashion by gripping and pulling the object 205, 305, 405, 410, 415, 505 out of the bore 105.

The device may sustain tactile, functional, and structural improvements over current options in that it may have a softer rubber touch, it may more easily accept items of various sizes, it may weigh less, and it requires no additional hardware to hold objects in place. It allows users with various dexterity needs to functionally grip and manipulate a variety of everyday objects. Current devices are limited by (i) their designs which attempt to improve the gripping surface of a particular object, (ii) rigid hardware used to secure an object within or to the device, and (iii) the use of complex means such as pneumatics for securing the object to the device.

The device improves upon similar devices in that it offers a larger gripping surface, includes flexible and semi-elastic internal structure for accepting and holding numerous common objects, does not require the need of threaded screws to hold the object in place, eliminates the need for a complex pneumatic system required to hold an object, and does not require an additional mechanism to rigidly secure an object to the device.

The embodiments provided here are examples only and are not intended to be a complete listing of possible embodiments, nor should they be construed as an exclusive listing of embodiments. Variations in the described invention and its uses are possible within the scope of this disclosure without departing from the subject matter coming within the scope of claims to be examined, and a reasonable equivalency thereof, which I regard as my invention.

I claim:

1. An apparatus for securing an object in such a manner as to make said object easy to handle by a person with limited hand mobility, said apparatus comprising:
a. a body comprised of semi-elastic material; and
b. said body defining one bore penetrating a substantially central axis of said body.

2. The apparatus of claim 1 further comprising said body being formed in a shape chosen from a member of the group consisting of ellipsoid, cylindrical, rectangularly solid, cubic, and spherical.

3. The apparatus of claim 1 further comprising said bore being formed in a shape chosen from a member of the group consisting of cylindrical, cubic, solid rectangular, and ellipsoid.

4. The apparatus of claim 1 further comprising said body defining lateral wings, said lateral wings being longitudinally joined with said bore.

5. The apparatus of claim 4 further comprising each of said lateral wings measuring substantially in the range of ¼″-2¾″ in width.

6. The apparatus of claim 1 further comprising said bore measuring substantially in the range of 1/32″-¾″.

7. The apparatus of claim 4 further comprising said lateral wings running the length of said bore.

8. An apparatus for securing an object in such a manner as to make said object easy to handle by a person with limited hand mobility, said apparatus comprising:
a. a body comprised of semi-elastic material;
b. said body defining one bore penetrating substantially a central axis of said body; and
c. said body also defining lateral wings, said lateral wings being longitudinally joined with and running the length of said bore.

9. The apparatus of claim 8 further comprising said body being formed in a shape chosen from a member of the group consisting of ellipsoid, cylindrical, rectangularly solid, cubic, and spherical.

10. The apparatus of claim 8 further comprising said bore being formed in a shape chosen from a member of the group consisting of cylindrical, cubic, solid rectangular, and ellipsoid.

11. The apparatus of claim 8 further comprising each of said lateral wings measuring substantially in the range of ¼″-2¾″ in width.

12. The apparatus of claim 8 further comprising said bore measuring substantially in the range of 1/32″-¾″.

13. An apparatus for securing an object in such a manner as to make said object easy to handle by a person with limited hand mobility, said apparatus comprising:
a body comprising semi-elastic material, said body being formed by injection molding and formed in a shape chosen from the group consisting of ellipsoid, cylindrical, rectangularly solid, cubic, and spherical;
said body defining one bore penetrating substantially a central axis of said body, said bore being formed in a shape chosen from a member of the group consisting of cylindrical, cubic, solid rectangular, and ellipsoid, and said bore measuring substantially in the range of 1/32″-¾″; and
said body also defining lateral wings, the number thereof being selected from the group consisting of one, two, three, four, five, and six, said lateral wings being longitudinally joined with and running the length of said bore, and said lateral wings measuring substantially in the range of ¼″-2¾″ in width.

14. A method for using an apparatus for securing an object in such a manner as to make said object easy to handle by a person with limited hand mobility, said method comprising:
a. gripping said apparatus in one hand;
b. inserting and sliding an object through one end of a central bore in said apparatus until said object protrudes a desired distance from an opposite end of said bore and is frictionally held in place; and
c. gripping an exterior portion of said apparatus to manipulate said object for the desired use of said object; and
d. after use, removing said object from said apparatus by gripping and pulling said object out of said bore.
